(19) United States
(12) Patent Application Publication
(10) Pub. No.: US 2010/0154565 A1
(43) Pub. Date: Jun. 24, 2010

(54) MICRO-SCALE OPTICAL FORCE SENSOR INCREASED DYNAMIC RANGE, AND HIGHER SENSITIVITY AND LINEARITY VIA A COMPLIANT LINKAGE,

(75) Inventors: Gloria J. Wiens, Newberry, FL (US); Gustavo Andres Roman, Gainesville, FL (US)

Correspondence Address: MH2 TECHNOLOGY LAW GROUP, LLP, 1951 KIDWELL DRIVE, SUITE 550, TYSONS CORNER, VA, 22182, US

(73) Assignee: The University of Florida Research Foundation, Inc, Gainesville, FL (US)

(21) Appl. No.: 12/522,471

(22) PCT Filed: Jan. 16, 2008
(86) PCT No.: PCT/US08/51183

§ 371 Date: Jul. 8, 2009

Related U.S. Application Data
(60) Provisional application No. 60/885,304, filed on Jan. 17, 2007.

(51) Int. Cl. G01L 1/04; G01B 11/16

(52) U.S. Cl. 73/862.624

(57) ABSTRACT

Exemplary embodiments provide a micro-scale optical force sensor. The device includes a scale grating, a linearly displaceable index grating positioned above and in initial alignment with the scale grating, the index grating aligned with the scale grating absent a force applied to the index grating, and a compliant linkage assembly joined coplanar to the displaceable index grating. The linkage assembly includes at least three rigid support links laterally extending from each of opposing longitudinal edges of the index grating, a displaceable rigid link formed between adjacent support links, and compliant links interposed between a distal end of rigid support links and an inner end of each displaceable rigid link, and interposed between an outer end of rigid support links and the substrate, the compliant links normally biasing the displaceable rigid link parallel to the rigid support links and perpendicular to a longitudinal axis of the index grating.

### RELATED APPLICATIONS

This application claims priority from U.S. Provisional Patent Application Ser. No. 60/885,304, filed Jan. 17, 2007, and is a national phase of PCT/US2008/051183, filed Jan. 16, 2008, both of which are hereby incorporated by reference in its entirety.

### FIELD

This invention relates generally to surface micromachined optical force sensor devices and, more particularly, to enhancing micromachined optical force sensor devices with compliant mechanisms.

### BACKGROUND

Force sensors can be found in a variety of configurations, including capacitive surface micromachined force sensors and optical based force sensors. In order to obtain a scale necessary for research in the fields of cell and tissue mechanics, manipulation and microinjection, force sensor devices will be on the order of hundreds of microns in size and produce or measure forces over ranges of micro, nano or pico Newtons. To achieve these scales, fabrication of the force sensor will require the use of surface micromachining and bulk etching technologies.

Research in micro-electromechanical systems (MEMS) has been conducted in order to develop physical force sensors and actuators on a micro scale. MEMS technology has provided significant advances in this field. A particular advantage of MEMS sensors and actuators is that they can incorporate multiple physical domains including mechanical, electrical, thermal, magnetic and optical. Some common means for sensing include capacitance, piezoelectric, piezoresistive and optical diffraction.

Of the known devices, optical diffraction based sensing has demonstrated the most promise. Optical based devices use interferometry to measure the displacement of a structure when an external load is applied. The stiffness of these structures is well defined and a spring relationship is used to decipher the magnitude of force causing the detected displacement. Optical detection can include fringe patterns, amplitude shifts and phase shifts. Of these, the most widely used method is to measure phase shifts. The change in phase of an incoming light source is caused by a distortion of a grating that it passes through. The distortion of the grating is directly related to the external loads being measured via deflections of a compliant structural component.

A typical “four beam” optical force sensor is found in the device of Zhang et al. “Micromachined Silicon Force Sensor Based on Diffractive Optical Encoders for Characterization of Microinjection,” Sensors and Actuators: A physical, 114(2-3), p. 197-203, incorporated by reference herein in its entirety.

The device of Zhang et al. is depicted by way of example in FIGS. 1A and 1B. The sensor 100 of FIG. 1A includes a linear optical encoder. The encoder consists of two identical constant period gratings, specifically a scale grating 110 and an index grating 120. The scale grating 110 is fixed to a substrate 130, and the index grating 120 is suspended above the scale grating and free to translate in a single direction with an applied force “F”. When no external load is applied to the index grating 120, the index grating is aligned with the scale grating 110. When a load is applied, for example to a microneedle 140 formed at an end of the index grating 120, the index grating moves relative to the scale grating 110. The relative movement between the gratings varies an amount of light passing through the device and thus an intensity of the diffracted orders. These changes in intensity are measured via photodiodes as depicted schematically in FIG. 2.

As depicted in FIG. 2 and by way of a general explanation only, a light source 260 passes through the diffractive linear gratings 210, 220. Displacement of the index grating 220 relative to the scale grating 210 varies the intensity of the diffracted orders. Changes in intensity are measured with photodiodes 270.

Continuing with FIGS. 1A and 1B, the index grating 120 is suspended above the scale grating 110 by compliant suspension beams 150 fixed at their outer ends to the substrate 130. The direction of translation for the device is considered the x-direction. The sensor is designed to be compliant in the x-direction while resisting motion in the other five degrees of freedom. Of those five, the sensor is most sensitive to z-axis rotation. To minimize this effect, the device uses maximally separated suspension beams 150 to maximize rigidity in the z-direction. For example, a pair of compliant suspension beams 150 is formed at a microneedle 140 end of the index grating 120 and a pair of compliant beams 150 is formed at the opposing end of the index grating 120.

A force applied to the microneedle 140 will cause the index grating 120 to displace. In order to determine the magnitude of force acting on the microneedle 140, the spring constant of the index grating 120 can be calculated. Given a minimum detectable displacement, defined by the optics and photodiodes, the spring constant determines the sensitivity of the sensor. The more compliant and thus movable the index grating, the smaller the minimum changes in force it may register. Magnitude of displacement can be calculated in a known manner with the Fraunhofer diffraction theory found in the Zhang at al. article. Using the Fraunhofer diffraction theory, a relationship between first diffraction mode intensity and injector displacement can be developed.

Optical force sensors typically lack an ability to apply a linear force over a predetermined distance (displacement) of force application. It is therefore an achievement of the exemplary design to maximize the linear relationship between the device input force and displacement while at the same time minimizing stiffness to improve the sensitivity of the device.

In order to optimize linear force over a predetermined distance, the exemplary development identifies a need in the art for improved linearity characteristics of the force sensor over a dynamic range. To accomplish this need, the exemplary sensor device uses a compliant mechanism which exhibits a straight line motion feature. A basis for the straight line compliant mechanism can be found in a “Roberts” type mechanism where articulated links are replaced by compliant links. It will be appreciated that an articulated link is essentially a pivot about which a rigid link can rotate. A compliant link functions as a joint but can move by flexing and stretching. An example of such a device termed “X-Bob” can be found in Hubbard at al., 2004, “A Novel Fully Compliant Planar Linear-motion Mechanism.” Proceedings of the 2004 ASME Design Engineering Technical Conferences, Salt Lake City, Utah, DETC2004-57008, incorporated by reference herein in its entirety.

For example, a Hubbard at al. type solution replaces pivot points of a Robert's mechanism with flexible mechanisms. An arrangement of up to eight Robert's type mechanisms can be formed around a common axis. A prototype of the X-Bob device 300 is depicted in FIGS. 3A and 3B. The X-Bob device 300 typically includes a center shuttle 310 with perpendicular beams 320 at outer ends of the center shuttle 310. A rigid yet displaceable beam 330 is suspended from adjacent discrete structures by a pair of compliant members 340. This arrangement suspends the displaceable beam 330 parallel to the perpendicular beams 320. Referring to FIG. 3B, when force is applied parallel to the center axis of the shuttle 310, the compliant members 340 enable the displaceable beam 330 to rotate in the direction of force such that displacement is substantially linear. However, the X-Bob only suggests expected applications in end-effectors, self-retracting ratcheting actuators, and linear suspension type devices. There is no disclosed sensitivity or intended near linear force over a predetermined displacement.

However, each of the Zhang et al. and Hubbard et al. devices have drawbacks and disadvantages, for example, due to limited applications, lack of design flexibility, and inability to provide a near linear force over a predetermined displacement.

Thus, there is a need to overcome these and other problems of the prior art and to provide devices and techniques for a micro scale surface micromachined linear optical force sensor with high sensitivity over an increased dynamic range.

### SUMMARY

According to various embodiments, the present teachings include a micro scale optical force sensor. The exemplary device can include a diffractive linear encoder having a scale grating formed on a support, a linearly displaceable index grating positioned above and in initial alignment with the scale grating, and a compliant linkage assembly joined coplanar to the displaceable index grating. The linkage assembly can include at least three rigid support links laterally extending from each of opposing longitudinal edges of the sensor member, a displaceable rigid link formed between adjacent support links, and compliant links interposed between rigid support links and displaceable rigid link, the compliant links normally biasing the displaceable rigid link parallel to the rigid support links and perpendicular to a longitudinal axis of the index grating. Further, means are provided for determining an output of the diffractive linear encoder, wherein an optical diffraction measurement is proportional to a force applied to the index grating.

According to various embodiments, the present teachings also include a constant force device. The constant force device can include a fixed support, a displaceable tool slidable on a substrate, and a compliant linkage assembly coupling the displaceable tool to the fixed support. The linkage assembly can include at least two rigid support links and a compliant link coupled between the rigid support links, the fixed support, and the displaceable tool. The compliant links normally bias the displaceable tool away from the fixed support, wherein the displaceable tool is configured to exhibit a substantially constant force over a predetermined displacement.

Additional embodiments will be set forth in part in the description which follows, and in part will be obvious from the description, or may be learned by practice of the disclosed embodiments. The embodiments will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments and together with the description, serve to explain the principles of the embodiments.

FIGS. 1A and 1B depict a known optical force sensor at various stages of fabrication in accordance with the present teachings.

FIG. 2 depicts a known optical diffraction sensor configuration in accordance with the present teachings.

FIGS. 3A and 3B depict top plan views of a known linear force mechanism in accordance with the present teachings

FIG. 4 depicts a top plan view of a portion of an exemplary optical force sensor in accordance with the present teachings.

FIG. 5 depicts a cross-sectional view of an exemplary optical force sensor in accordance with the present teachings.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g., −1, −2, −3, −10, −20, −30, etc.

Exemplary embodiments provide compliant solutions for a variety of force sensors. In particular, an exemplary surface micromachined optical force sensor device comprises a compliant mechanism enabling the force sensor to engage with a constant linear force over a predetermined distance in a manner not previously achieved in the art. The device can include an optical encoder, the optical encoder including a fixed scale grating and a displaceable index grating suspended over the scale grating. The index grating can be suspended with a compliant linkage assembly that imparts linear, highly sensitive movement to the index grating over a predetermined displacement.

Further, the device is particularly applicable to micro scale biomedical devices used in biomedical research. For example, the device is particularly suited for in vivo experiments (i.e. RNA interference) because a determination of a required injection force can be made for penetrating a membrane. The device can minimize damage to cells attributed to injection and thereby preserve specimens. Additionally, the device is particularly suited to cancer research, and more specifically to investigating mechanical properties of cancer cells, and comparing cancer cells with healthy cells to distinguish therebetween. Additionally, the device is also well suited for cell and tissue mechanics research in particular adhesion studies through introduction of multiple force probes arranged in various experimental configurations. Further scaling the size of the invention and/or embedding it within mesoscale systems, the device can provide increased sensing capabilities for micro/mesoscale applications from medical to micro-manufacturing applications.

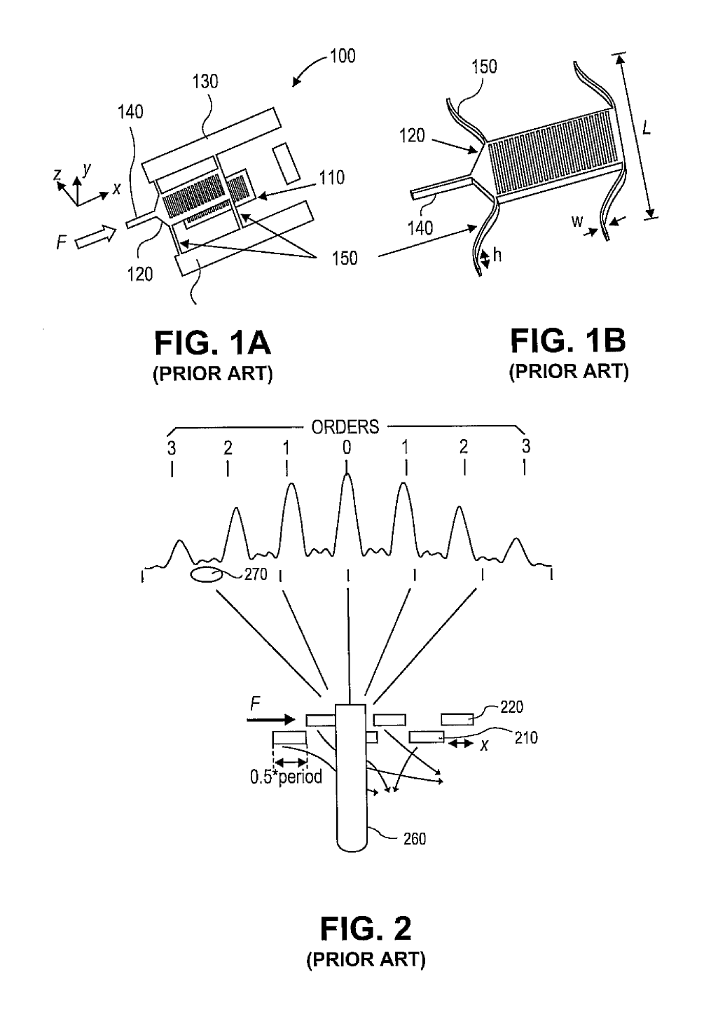

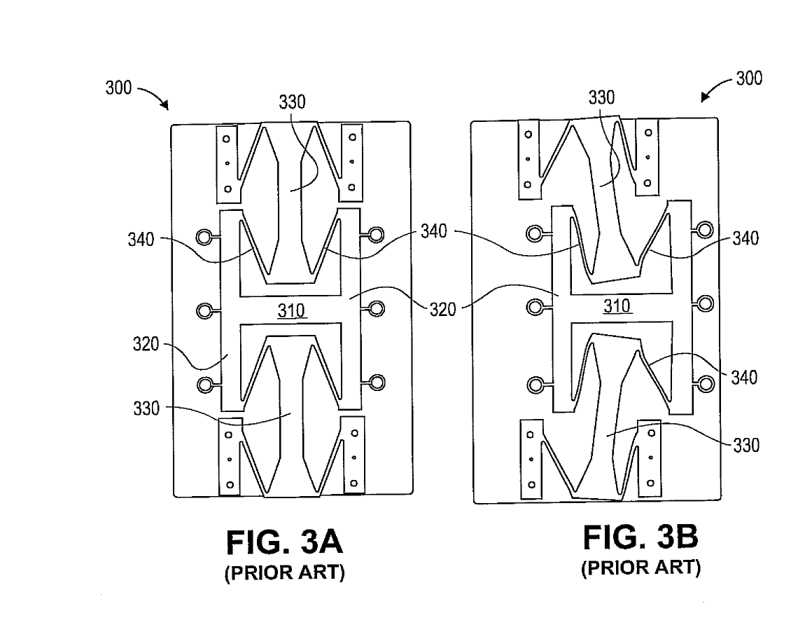

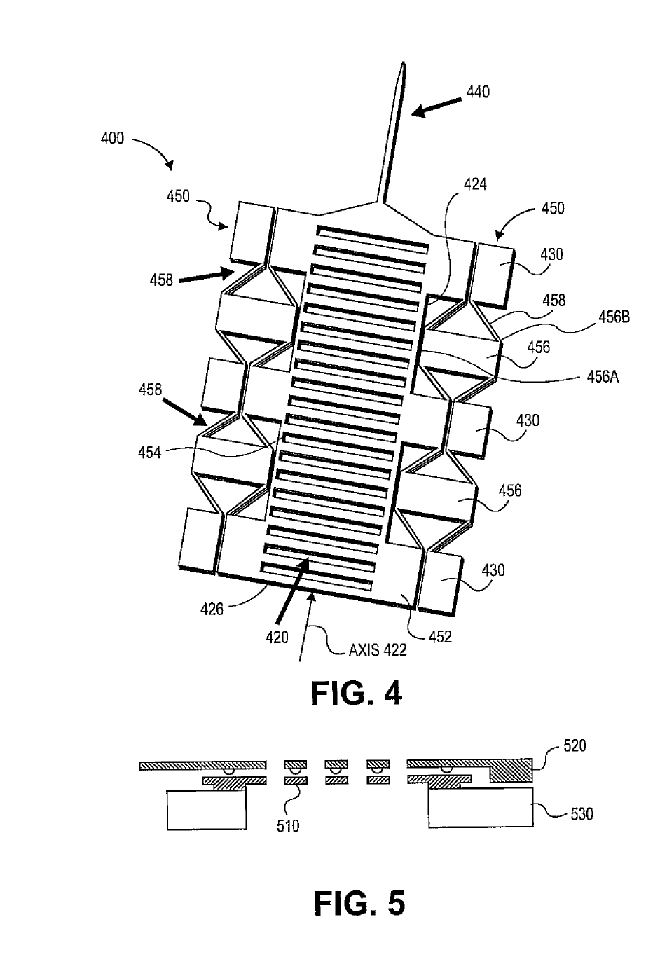

FIG. 4 depicts a top plan view of an exemplary portion 400 of a sensor device in accordance with the present teachings. The portion 400 is intended for incorporation into an optical force sensor such as that described in connection with FIGS. 1A and 1B, essentially replacing the index grating and four beam suspension described therein. A side view of the portion 400 of the sensor with remaining components of the optical force sensor is shown in further detail in FIG. 5. It should be readily apparent to one of ordinary skill in the art that the portion 400 of a sensor device depicted in FIG. 4 represents a generalized schematic illustration and that other layers/structures can be added or existing layers/structures can be removed or modified.

In FIG. 4, the device 400 can include an index grating 420 for use in a diffraction based optical sensor. The index grating 420 can include a compliant linkage assembly 450 for providing a linear motion over a predetermined displacement of the index grating 420.

The index grating 420 can be further characterized as including a longitudinal center axis 422. In addition, the index grating 420 can include longitudinal edges 424 parallel to the longitudinal axis 422 and lateral edges 426 perpendicular to the longitudinal edges 424. The index grating 420 is substantially planar as known in the art. A functional tool 440 can be formed on a lateral edge 426 of the index grating 420. Exemplary functional tools for use with the device can include micro-needles, probes, push or pull tools, grippers or clamps, and other known biomedical instruments used to capture properties of cells.

The exemplary index grating 420 is intended for use in an optical based sensor, the sensing based on a diffractive linear encoder. The linear encoder (as depicted further in FIG. 5) can include two identical constant period gratings, specifically a scale grating 510 (see FIG. 5) and the index grating 520. The scale grating 510 is fixed to a substrate 530, and the index grating 520 is suspended above the scale grating 510 with the exemplary compliant linkage assembly 450 for linear displacement. When no external load is applied to the index grating 520, the index grating is aligned with the scale grating 510. When a load is applied, for example to a microneedle 440 formed at an end of the index grating 520, the index grating 520 moves relative to the scale grating 510. The relative movement between the gratings varies an amount of light passing through the device and thus an intensity of the diffracted orders. These changes in intensity are measured via photodiodes as described, for example, in connection with FIG. 2.

With reference to FIG. 4, the compliant linkage assembly 450 can include, for example, at least three rigid support links 452 laterally extending from each of opposing longitudinal edges 454 of the index grating 420. A displaceable rigid link 456 can be formed between adjacent support links 452. Compliant links 458 can be interposed between a distal end of the rigid support links 452 and an inner end 456a of the displaceable rigid link 456. Compliant links 458 can further be interposed between an outer end 456b the displaceable rigid link 456 and substrate 430. In this configuration, the compliant links 458 normally bias the displaceable rigid link 456 parallel to the rigid support links 452 and perpendicular to the longitudinal axis 422 of the index grating 420.

The compliant linkage assembly 450 and index grating 420 can be integrally formed by a surface micromachining process. Fabrication can be performed with thick (12 μm) surface micromachining technology in which a layer of polysilicon silicon is micromachined to form the index grating 420 connected to the compliant linkage assembly 450. The compliant linkage assembly 450 can be anchored on the silicon substrate 430 with the surface micromachining process.

A selection of geometric parameters can be made to yield devices with predetermined sensitivity and displacement characteristics. For example, a length of the compliant links 458 can be varied. Likewise, a width of the compliant links 458 can be varied. Further, an angle of the compliant links 458 with respect to an adjacent displaceable rigid link 456 and substrate 430 can be varied.

With the exemplary configuration, variations can be made to the width, length, and angle of the compliant links 458 in order to configure a displacement, sensitivity (spring constant) and linear force over the displacement range. The configuration can maximize linearity while minimizing overall stiffness of the index grating 420 and hence sensor.

A baseline of design parameters can include a compliant link width of 2 μm, a compliant link length of 222 μm, a coupling link length of 108.3 μm, and a rigid displacement link length of 261 μm to a center point of the link, with an initial compliant link angle of 72.5°. These parameters correspond to an index grating displacement of 70 μm. These parameters yield the index grating 420 of FIG. 4 having a spring constant of 0.57 N/m, only about 25% of the four beam design of Zhang et al. and Hubbard et al. Further, the index grating will have a large enough displacement range to handle an average 58 μm deformation of an embryo before penetration. To distinguish, in the four-beam sensor of Zhang et al., non-linearities begin to dominate after only 15 μm of displacement, whereas the exemplary index grating remains virtually linear throughout the entire displacement range. Therefore, the force can be simply calculated using the predetermined spring constant and computed displacement.

An exemplary linear displacement range can be from about 70 μm to about 200 μm. An exemplary length of the compliant links 458 can be from about 178 μm to about 266 μm. An exemplary width of the compliant links can be from about 1 μm to about 3 μm. Finally, an exemplary initial angle of the compliant link with respect to the rigid support links 452, substrate 430, or displaceable rigid link 456 can be from about 20° to about 73°.

While these parameters are exemplary, it will be appreciated that additional exemplary parameters for the width of the compliant link can be used. Increasing the width of the compliant links can reduce the non-linearity of the device; however maximum displacement can also be decreased. There is a similar inverse relationship found between the sensing range and the sensitivity. If a device is needed for μN applications with high resolution, a smaller width can provide a solution yielding lower stiffness. On the other hand, the width can be increased and enable the device to sense in the μN rage with a reduction in resolution. In addition to these exemplary ranges of the device parameters, these dimensions can be scaled to yield other embodiments of the force transducer in terms of its physical size and dynamic sensing ranges, constrained in application by the capabilities of the optics and fabrication processes available.

Exemplary materials for the sensor device can include silicon for the substrate, and silicon nitride for each of the scale grating, index grating, and corresponding compliant linkage assembly. It will be appreciated that silicon nitride is selected for its particular applicability to surface micromachining as well as brittleness factor. Other materials suitable to the exemplary structure and characterized features can also be used.

A combination of the exemplary index grating with the exemplary compliant linkage assembly enables a larger linear range, utilizes a very small stiffness without compromising linear movement, reduces optical errors, reduces measurement errors due to elimination of structural variations, and can be easily tailored to comply with requested parameters.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A micro-scale optical force sensor comprising:
a diffractive linear encoder comprising:
a scale grating formed on a substrate;
a linearly displaceable index grating positioned above and in initial alignment with the scale grating, wherein the index grating is aligned with the scale grating in absence of a force applied to the index grating; and
a compliant linkage assembly joined coplanar to the displaceable index grating, the linkage assembly comprising:
at least three rigid support links laterally extending from each of opposing longitudinal edges of the index grating;
a displaceable rigid link formed between adjacent support links; and
compliant links interposed between a distal end of rigid support links and an inner end of each displaceable rigid link, and interposed between an outer end of rigid support links and the substrate, the compliant links normally biasing the displaceable rigid link parallel to the rigid support links and perpendicular to a longitudinal axis of the index grating; and
means for determining an output of the diffractive linear encoder in response to a force applied to the index grating.

2. The device of claim 1, wherein a single compliant link is interposed at each location.

3. The device of claim 1, wherein each compliant linkage assembly comprises a pair of displaceable rigid links on opposing lateral sides of the index grating.

4. The device of claim 3, wherein each pair of displaceable rigid links includes a common rigid support link.

5. The device of claim 1, further comprising selectively varying a width of each compliant link according to an overall selected stiffness of the linkage assembly.

6. The device of claim 1, wherein a linear displacement range of the index grating is from about 70 μm to about 200 μm.

7. The device of claim 1, wherein the compliant linkage assembly maintains a linear relationship between force and displacement over a dynamic range of the sensor device.

8. The device of claim 1, further comprising varying an angle of the compliant links with respect to a corresponding rigid link, substrate, and displaceable rigid link according to a selected linear sensitivity of the sensor.

9. The device of claim 1, further comprising varying a length of the compliant links according to a selected linear sensitivity of the sensor.

10. The device of claim 1, further comprising varying a width of the compliant links according to a selected linear sensitivity of the sensor.

11. The device of claim 1, wherein compliant linkage assemblies are mirrored about the center longitudinal axis of the index grating.

12. The device of claim 1, wherein compliant links are shorter and thinner than rigid links.

13. The device of claim 1, wherein the compliant linkage assembly is integrally formed with the index grating.

14. The device of claim 1, wherein the sensor comprises surface micromachined components.

15. The device of claim 1, further comprising a tool connected to the index grating.

16. The device of claim 15, wherein the tool comprises a microneedle.

17. The device of claim 1, wherein the displaceable index grating exhibits a substantially linear force-displacement relationship over a given displacement range.

18. The device of claim 1, wherein a predetermined ratio of rigid link lengths and compliant link spring constants are configured to provide a substantially linear force-displacement relationship over a given displacement range.

19. The device of claim 1, wherein the index grating resists displacement along an axis of applied force.

20. A micro-scale optical force device comprising:
a scale grating formed on a substrate;
a linearly displaceable index grating positioned above and in initial alignment with the scale grating, wherein the index grating is aligned with the scale grating in absence of a force applied to the index grating; and
a compliant linkage assembly joined coplanar to the displaceable index grating, the compliant linkage assembly partially anchored to the substrate and enabling a linear motion of the index grating throughout substantially an entire displacement range.
